(19) United States
(12) Patent Application Publication
(10) Pub. No.: US 2026/0087812 A1
(43) Pub. Date: Mar. 26, 2026

(54) ARTIFICIAL INTELLIGENCE INTERVENTION TO DETECT AND MITIGATE AN ABNORMALIITY IN MOTION OF AN OBJECT DURING A PROCESS

(71) Applicant: INTERNATIONAL BUSINESS MACHINES CORPORATION, ARMONK, NY (US)

(72) Inventors: Hamid Majdabadi, OTTAWA (CA); Jeremy Ray Fox, Georgetown, TX (US); Su Liu, Austin, TX (US); Martin G. Keen, Cary, NC (US)

(21) Appl. No.: 18/890,951

(22) Filed: Sep. 20, 2024

(51) Int. Cl. G06V 20/52; G06Q 20/18; G06V 10/774; G06V 10/778; G06V 10/82

(52) U.S. Cl. CPC G06V 20/52; G06Q 20/18; G06V 10/774; G06V 10/778; G06V 10/82

(57) ABSTRACT

A method, computer program product, and computer system of artificial intelligence (AI) intervention to detect and mitigate an abnormality associated with an object moving during performance of a process. A trained recurrent neural network (RNN) determines, from sensor data, a probability (Pr1) that the abnormality existed at a first time, where Pr1 exceeds a threshold T1 and in response, an alternative generative adversarial network (AGAN) determines a probability (Pa1) that the abnormality existed at the first time. A score S1, which is computed as a function of Pr1 and Pa1, exceeds T1 and in response the RNN and the AGAN determines, from the senso data, a probability (Pr2) and a probability (Pa2), respectively, that the abnormality existed at a second time. A score S2, which is computed as a function of at least Pr2, Pa2, and (S1-T1), exceeds a threshold (T2) and in response, the abnormality is mitigated.

### BACKGROUND

The present invention relates to detection of 1an abnormality associated with a moving object, and more specifically, to 1detection and mitigation of an abnormality associated with an object moving during performance of a process.

### SUMMARY

Embodiments of the present invention provide a method, a computer program product, and a computer system, of 1artificial intelligence (AI) intervention to detect and mitigate an abnormality associated with an object moving during performance of a process.

1Sensor data collected by sensors tracking aspects of the moving object is 1received at a first time during a pre-final stage of the process.

1 In response to a determination that Pr1 exceeds a specified threshold (T1) wherein 0 <T1<100, 1an initially trained alternative generative adversarial network (AGAN) determines, from the received sensor data collected by the sensors at the first time, a probability (Pa1) that the abnormality existed at the first time, wherein the AGAN is a generative adversarial network (GAN) or a conditional generative adversarial network (CGAN), wherein the AGAN comprises a generator and a discriminator, and wherein determining Pa1 comprises further training the AGAN by improving only the generator or only the discriminator.

1A score S1 is computed as a function of Pr1 and Pa1, wherein 0<S1<100.

It is 1determined that S1 exceeds T1 and in response, it is determined, by the trained RNN and the trained AGAN from the received sensor data collected by the sensors at a second time during a final stage of the process, a probability (Pr2) and a probability (Pa2), respectively, that the abnormality existed at the second time, and wherein determining Pa2 comprises additionally training the AGAN by improving only the generator or only the discriminator.

1 A score S2 is computed as a function of at least Pr2, Pa2, and a T1 breach B=(S1−T1), wherein 0<S2<100.

It is 1determined that S2 exceeds a specified threshold (T2) wherein T1<T2<100 and in response, the abnormality is mitigated which improvs the performance of the process.

### BRIEF DESCRIPTION OF THE DRAWINGS

FIG. 1 is a diagram of a computer architecture for implementing a method of artificial intelligence (AI) intervention to detect and mitigate an abnormality associated with an object moving during performance of a process, in accordance with embodiments of the present invention.

FIG. 2 is a flow chart of a method of artificial intelligence (AI) intervention to detect and mitigate an abnormality associated with an object moving during performance of a process, in accordance with embodiments of the present invention.

FIG. 3 is a flow chart describing in detail a step of FIG. 2 which initializes system components, in accordance with embodiments of the present invention.

FIG. 4 is a flow chart describing in detail a step which initializes the collection of sensor data, in accordance with embodiments of the present invention.

FIG. 5 is a flow chart describing in detail a step of FIG. 2 which monitors and detects an abnormality associated with a moving object during performance of a process, in accordance with embodiments of the present invention.

FIG. 6 is a flow chart describing in detail a step of FIG. 5 which 1determines, by an 1alternative generative adversarial network (AGAN), a probability (Pa1) that an abnormality existed at a first time 1during a pre-final stage of the process, in accordance with embodiments of the present invention.

FIG. 7 is a flow chart describing in detail a step of FIG. 5 which 1determines, by the alternative generative adversarial network (AGAN), a probability (Pa2) that an abnormality existed at a second time 1during a final stage of the process, in accordance with embodiments of the present invention.

FIG. 8 illustrates a computer system, in accordance with embodiments of the present invention.

FIG. 9 depicts a computing environment which contains an example of an environment for the execution of at least some of the computer code involved in performing the inventive methods, in accordance with embodiments of the present invention.

### DETAILED DESCRIPTION

Embodiments of the present invention implement 1artificial intelligence (AI) intervention to detect and mitigate an abnormality associated with an object that is moving during performance of a process.

In one embodiment, the process is a commercial transaction with a customer and the object is a good that can be purchased by the customer via the commercial transaction. An abnormality associated with the object's motion and associated locations may indicate an attempt by the customer to complete the commercial transaction in a fraudulent manner.

In one embodiment, the process is an assembly line process and the object is a part being moved on an assembly line 1via the assembly line process to a destination at which the part is to be assembled into a machine being manufactured. An abnormality associated with the object's motion and associated locations may indicate errors and/or defects in the assembly line process.

In one embodiment, the process is a delivery process and the object is a good to be delivered to a destination by a vehicle via the delivery process. An abnormality associated with the object's motion and associated locations may indicate errors and/or defects in the delivery process.

In one embodiment, the process is 1a medical diagnostic process and the object is a radioactive tracer that is moved through a portion of patient's body to provide information needed by the medical diagnostic process to diagnose a medical condition of the patient. An abnormality associated with the object's motion and associated locations may indicate errors and/or defects in the medical diagnostic process.

The scope of embodiments of the present invention includes any process in which there is an abnormality associated with an object that is moving during performance of a process.

For illustrative purposes, a description of embodiments of the present invention with respect to a commercial transaction is presented next.

Customers benefit from the convenience and speed of self-checkout technologies, which have revolutionized the retail industry. However, there are certain drawbacks to such technologies, such as usability and legibility limitations, as well as fraud and security concerns. Self-checkout systems are subject to threats of fraudulent behaviors such as barcode switching and underreporting products, and businesses are developing security measures to mitigate these threats, including AI-based fraud detection. Despite these threats, self-checkout use is on the rise, driven by convenience and a desire for contactless payments, which has been increased by the COVID-19 pandemic.

An increasing number of self-checkout counters in retail contexts has introduced issues, such as an increasing number of fraudulent activities. Self-checkout systems, designed to speed up transactions, have unwittingly created possibilities for dishonest people to engage in various forms of deception. The fraudulent behaviors occurring at self-checkout counters include deceptive actions such as underreporting items, purposeful product misidentification, and payment process manipulation. These deceptive actions not only compromise retailer revenue but also undermine the trust and efficiency of self-checkout systems, requiring comprehensive responses to ensure fair and secure transactions for all customers and businesses involved. According to one study, fraudulent transactions conducted through self-service checkout machines account for 9% of losses caused by customer/shopper dishonesty.

Traditional methods of deception detection often fall short in the context of self-checkout, where the absence of direct human supervision can be exploited.

Embodiments of the present invention use an intelligent Internet of Things (IoT) network correlated with generative AI to monitor, detect, identify, and alert anomalies and/or abnormalities during a self-checkout transition.

Embodiments of the present invention use an intelligent and novel method that combines contextual IoT network data obtained from IoT sensors, combined with generative AI to create adaptive behavior profiles and corrective measure leveraging synthetic data simulating fraudulent patterns coupled with a visual generation during a self-checkout transaction. By analyzing customer behavior patterns and detecting deviations in real-time, embodiments of the present invention can identify potentially fraudulent activities and trigger immediate checkout adjustment and notification of intervention to prevent self-checkout deception.

The IoT sensors capture transaction data, product data, behavioral biometrics, and behavioral profiles, while generative AI algorithms analyze this data in real-time to detect anomalies and patterns associated with fraudulent behavior and generate a visual associated with the questionable transaction. Embodiments of the present invention correlate confidence thresholds to trigger corrective actions to adjust the transaction and adjust an auto-charge as warranted by on-demand recorded visual display of a discrepancy during the check-out or by a link attached to a digital receipt. Additionally, when suspicious activity is detected, alerts may be triggered for immediate intervention by personnel monitoring the transition.

The evolution of self-service checkout technology has significantly altered the retail landscape, providing customers with swifter and more convenient transactions accelerated by the onset of the COVID-19 pandemic. Self-service checkout systems have become widely accepted within retail settings due to their efficiency and ease of use. Nevertheless, self-service checkout systems remain susceptible to deceptive practices such as altering barcodes, inaccurately reporting items, and manipulating payment procedures. Embodiments of the present invention harness the capabilities of generative AI and IoT networks to effectively detect such deceptive practices and prevent instances of deception within self-service checkout environments. Despite the benefits, challenges (including concerns regarding unethical activities such as barcode alteration and item underreporting which exploit vulnerabilities in self-service checkout systems) are responded to by embodiments of the present invention by using AI-driven deception detection to combat these challenges. Despite all preventative measures, some major retailers are bringing back the cashier counters as the major retailers notice growing losses at the self-checkout counters characterized by individual counter supervision to achieve some level of accuracy.

Embodiments of the present invention leverage contextual IoT network indicators empowering adaptive generative AI to monitor, detect, identify, adjust, and communicate (e.g., by an alert) anomalies during a self-checkout transition during a commerce transaction. A focal point of novelty of embodiments of the present invention is an integration of IoT sensors and generative AI, resulting in a dynamic adjustment of discrepancies during the self-checkout.

Embodiments of the present invention self-adjust AI output and adapt to real-time IoT network sensor data in a self-checkout domain.

Embodiments of the present invention generate, by the AI, an adaptive behavior profile correlated to the real-time IoT network indicators.

Embodiments of the present invention trigger the generative AI directive by a parameterized confidence threshold to invoke an AI method such as Recurrent Neural Network (RNN) and conditional generative adversarial network (CGAN) to generate a transactional visual image and to analyze behavioral gestures.

Embodiments of the present invention train the generative AI with generated synthetic data simulating fraudulent patterns in self-checkout transactions to detect and prevent new and evolving deception techniques.

Embodiments of the present invention create, by the generative AI, and store visual images of cart items to be recorded and compared with anomalies during the self-scan.

Embodiments of the present invention capture a real-time transaction discrepancy identified or suggested by a visual delta record visually depicting the real-time transaction discrepancy.

Embodiments of the present invention apply, by the generative AI based on confidence thresholds, corrective actions supported with a comparative visual transaction discrepancy in the checkout display.

Embodiments of the present invention apply corrective measures to adjust the transaction discrepancies with a link to visual records as an option in consumer transaction records.

Embodiments of the present invention broadcast transaction anomalies to relevant personnel in parallel to taking corrective action to resolve the transaction anomalies.

Embodiments of the present invention use existing wireless communication networks (e.g., Wi-Fi®, Bluetooth®, Zigbee®, etc.) to connect IoT sensors and devices, which enables real-time data transmission and communication between the self-checkout system and the AI system.

Embodiments of the present invention use edge computing devices to process and analyze data from IoT sensors locally, reducing latency and improving the responsiveness of the self-checkout system.

Embodiments of the present invention use cloud platforms to store, manage, and analyze data from the self-checkout system, enabling remote monitoring, updates, and maintenance of the data.

Embodiments of the present invention use a recurrent neural network (RNN) to analyze sequential data of customer actions. RNNs excel due to their ability to capture temporal dependencies, recognizing trends and anomalies in behaviors over time. For example, in a retail environment, RNNs can assess shopping actions such as browsing and purchasing to spot patterns and deviations, even predicting future actions. Memory of past events by RNNs helps capture context, where the context makes the past events more valuable for behavior detection across commerce sectors.

Embodiments of the present invention use a generative adversarial network (GAN) or a conditional generative adversarial network (CGAN) to generate realistic visual images of fraudulent activities. The GAN and the CGAN each include two networks, namely a generator and a discriminator, competing in a zero-sum game involving (i) an attempt by the discriminator to determine whether a synthetic image of potentially fraudulent activity is synthetic or real where the image was generated by the generator based on the sensor data and (ii) an attempt by the generator to fool the discriminator by making the generated image appear to be a normal image of non-fraudulent activity. The CGAN adds context to this process, allowing the visual images to be tailored to specific conditions. Use of the generator to create synthetic visual images can enhance deception detection system training by simulating different deception scenarios and improving the deception detection system's ability to recognize and prevent fraudulent activities.

Embodiments of the present invention use IoT sensors during self-checkout in a retail setting to prevent fraud. The IoT sensors include weight sensors for item verification, RFID scanners for accurate tracking, camera systems for visual surveillance, barcode scanners to prevent switching, and motion detectors to monitor customer behavior.

Embodiments of the present invention collect product and user behavior data and present the data to the self-checkout stations. The data includes barcodes, images, data collected by optical sensors, motions, derivative actions, and descriptions of the products being scanned. The data is sent to a cloud or edge computing platform.

Embodiments of the present invention transmit and store the data collected by the IoT devices in a cloud or edge computing platform, where RNN and GAN methods can access and analyze the data.

Embodiments of the present invention use encryption or authentication techniques to ensure data privacy and security.

Embodiments of the present invention display or play the outputs generated by RNN and GAN methods to the customers or the staff, using a visual point of sale (POS) screen or mobile devices, in addition to integrating generated visual images with a receipt for the purchase of goods.

Embodiments of the present invention use generative AI models such as Recurrent Neural Network (RNN) to capture temporal dependencies and recognize trends and anomalies in behaviors over time. In addition, AI models such as generative adversarial networks (GANs) or conditional GANs (CGANs) are used to create synthetic datasets that simulate fraudulent checkout patterns and analyze behavioral gestures from IoT feeds. IoT sensors can provide the data source for RNN and GAN methods, by collecting various types of data from the self-checkout stations, such as the weight, size, shape, color, texture, label, barcode, and price of the items being scanned, as well as the voice, biometric data, eye movements, gestures, or emotions of the customers using the self-checkout system.

Embodiments of the present invention combine contextual IoT network indicators to empower generative AI methods to create data of adaptive behavior profiles and corrective measure. This data set can be used to combine machine learning training models to recognize and adapt to various consumer behaviors and generate synthetic visual images of fraudulent activity verified for comparative disparity with real images of non-fraudulent activity during the transaction.

Embodiments of the present invention access the sensor data from the cloud or edge computing platform and feed the sensor data to a GAN or CGAN whose generator creates synthetic visual images (or videos) of the products based on the sensor data and sends the synthetic visual images (or videos) to the discriminator to compare the synthetic visual images with real visual images, and the discriminator tries to determine authenticity of the synthetic visual images. The discriminator sends feedback to the generator, telling the generator the extent to which the generated synthetic visual images are realistic. Fed by discriminator output, the generator augments the generator's ability to create a realistic visual image from the sensor data. The GAN or CGAN output is combined with the RNN output to compute a score to compare with a confidence preceding operation of the GAN or CGAN on the sensor data. The synthetic visual and behavioral sensor data is used to train machine learning models (e.g., the RNN, and the GAN or CGAN) to identify patterns and anomalies associated with fraudulent checkout activities.

Embodiments of the present invention normalize the collected IoT sensor data, ensuring that the sensor data is ready for analysis by the RNN. Relevant features, such as product information, customer actions, and transaction details, are extracted from the raw sensor data to be used as input to the RNN. The preprocessed data and extracted features are then fed into the RNN as a sequence of inputs, allowing the RNN to capture dependencies and patterns in the data over time. The RNN is trained on the sequence of inputs to learn patterns and relationships associated with fraudulent activities at self-checkout systems to detect specific fraudulent behaviors or predict a potential deviation.

Embodiments of the present invention take action, based on a confidence threshold, as a result of final AI output. The confidence threshold is a deciding factor as to whether a scan adjustment is required to resolve fraudulent action. Generated data representing an outcome of a gesture data analytic is reported back to the IoT network.

Embodiments of the present invention perform a comparative visual process which can be a stand-alone process or in combination with the preceding AI process if triggered by a detected behavioral anomaly and comprises: (a) comparing a generated product visual with an actual scanned transition at the self-checkout; (b) detecting a visual disparity once the scanned item does not match the visual image; (c) when applicable, correlating the visual disparity with the relevant behavioral and gesture image; (d) in response to the confidence threshold, auto-adjusting the detected discrepancy; (e) displaying the auto-adjusted discrepancy on a display screen; and (f) learning, by the system, how to optimize the comparative visual process through consumer reaction to the displayed auto-adjusted discrepancy (e.g., dispute the charge, call for help, etc.).

Embodiments of the present invention perform a real-time transaction intervention via (a) alerting, by the IoT network, a module to trigger an internal event monitoring and following up with the focusing on additional stress in monitoring the transaction during the self-checkout; an (b) auto-adjusting the transaction to reflect a correct match of the input code/name or missing scan.

Next presented are use cases of ticket switching, product swapping, item passing, and sweethearting that could occur during a commercial transaction.

Ticket switching is a type of self-checkout anomaly where the customer replaces the barcode or price tag of a more expensive item with the barcode of a cheaper item and scans the barcode or price tag of the cheaper item at the self-checkout. This way, the customer pays less than the actual price of the item, which is a fraud imposed on the store.

The customer is in a supermarket shopping store and picks up some apples at $1.99 per pound, and also notices at the bananas are priced at 40 cents per pound. The customer approaches the self-checkout counter and places a bag of apples on the weight scale and enters the code for banana instead. Ticket switching is a common and costly form of self-checkout fraud and can be hard to detect and prevent.

The retail department of the store opts-in to the invention module and next time when the customer attempts to repeat the same gestures looking at the banana barcode without picking the bananas up, the system detects an anomaly in the expected gesture compared to trained data. The invention module is already alerted, and visual images of all cart items are prepared. The customer starts the self-checkout transactions and, once the customer inputs the banana code instead of the apple code, the system detects the disparity and auto-adjusts the barcode and price displaying in real-time in the checkout display monitor. The customer receives a receipt that also includes a digital link if the customer inquires why the corrective measures are taken.

Product swapping occurs if the customer scans a cheaper product but puts a more expensive product in the customer's bag. For example, the customer scans a bottle of water, but puts a bottle of wine in the customer's bag, resulting in the customer paying for the cheaper product (water), but obtaining the more expensive product (wine).

Item passing occurs if the customer scans an item but passes the item to another person without putting the item in the customer's bag. For example, the customer scans a pack of gum, but gives the pack of gum to the customer's friend who is waiting outside the store, resulting in the customer obtaining the pack of gum without paying for the pack of gum.

Sweethearting occurs if the customer colludes with a store employee who is supervising the self-checkout station. The store employee can help the customer scan fewer items, scan wrong items, or scan lower-priced items. For example, the store employee can scan one item for every two items that the customer puts in the customer's bag, resulting in the customer paying less than the actual price of the item and sharing the profit with the store employee.

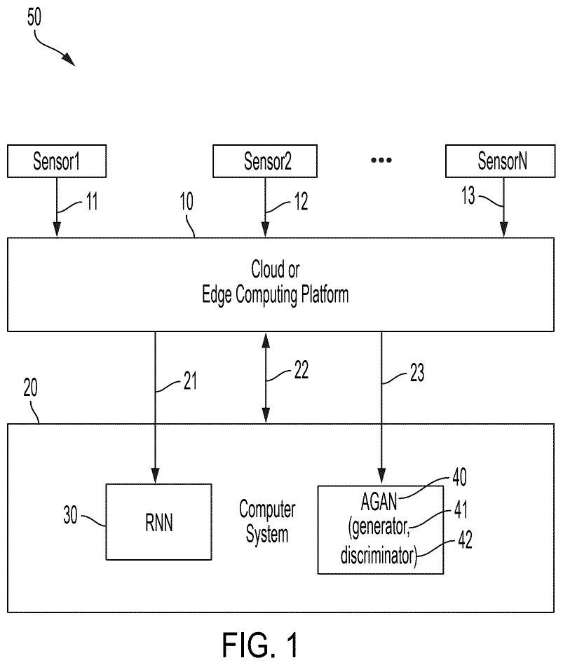

FIG. 1 is a diagram of a computer architecture 50 for implementing a method of artificial intelligence (AI) intervention to detect and mitigate an abnormality associated with an object moving during performance of a process, in accordance with embodiments of the present invention.

An abnormality is abnormal data that deviates from normal data. Normal data is data that is expected based on typical past occurrences of the data and/or based on a specified definition of the scope of normal data. For example, fraudulent data associated with a commercial transaction is an example of abnormal data.

In one embodiment, the process is a commercial transaction with a customer and the object is a good that can be purchased by the customer via the commercial transaction. An abnormality associated with the object's motion and associated locations may indicate an attempt by the customer to complete the commercial transaction in a fraudulent manner. The commercial transaction process was described supra.

In one embodiment, the process is an assembly line process and the object is a part being moved on an assembly line 1via the assembly line process to a destination at which the part is to be assembled into a machine being manufactured. An abnormality associated with the object's motion and associated locations may indicate errors and/or defects in the assembly line process.

In one embodiment, the process is a delivery process and the object is delivered to a destination by a vehicle via the delivery process. An abnormality associated with the object's motion and associated locations may indicate errors and/or defects in the delivery process.

In one embodiment, the process is 1a medical diagnostic process and the object is a radioactive tracer that is moved through a portion of patient's body to provide information needed by the medical diagnostic process to diagnose a medical condition of the patient. An abnormality associated with the object's motion and associated locations may indicate errors and/or defects in the medical diagnostic process.

The scope of embodiments of the present invention includes any process in which there is an abnormality associated with an object that is moving during performance of a process.

All features and techniques described supra for the commercial transaction process, which are not specific to the commercial transaction process, are applicable to all other processes that are within the scope of embodiments of the present invention.

The computer architecture 50 includes a computer system 20, a cloud or edging computing platform 10, and N sensors (i.e., sensor1, sensor 2, . . . , sensor N) wherein N is at least 2.

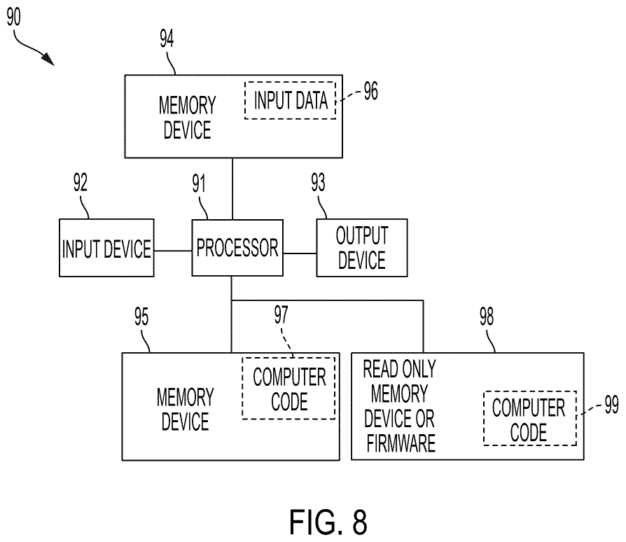

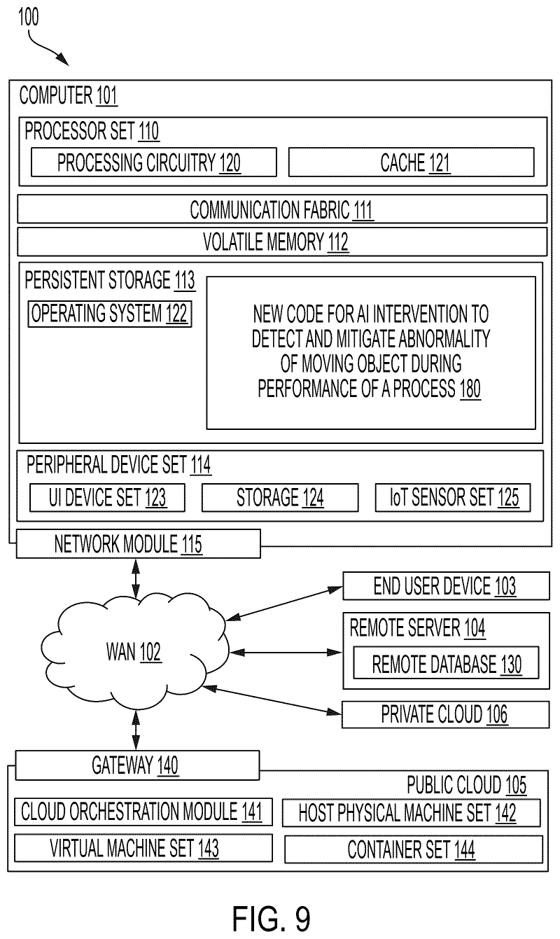

The computer system 20 represents either the computer system 90 in FIG. 8 or the computing environment 100 in FIG. 9. The computer system 20 comprises a recurrent neural network (RNN) 30 and an 1alternative generative adversarial network (AGAN) 40.

The RNN 30 is designed for processing sequential data, where the order of the data points is important, and form cycles that allow information from previous time steps to persist and influence decisions at later time steps. Thus, for data in a sequence such that one data point depends upon the previous data point, the RNN 30 is modified to incorporate the dependencies between the data points. Accordingly, the RNN 30 stores the states or information of previous inputs to generate the next output of the sequence. In addition, the RNN 30 is trained using backpropagation through time in which gradients are computed not only for the current input but for previous inputs as well. Accordingly, the RNN 30 is able to capture temporal dependencies, recognizing abnormalities in behaviors over time. For example, in a retail commercial transaction, the RNN 30 can assess shopping actions like browsing and purchasing to spot patterns and deviations, even predicting future actions. The memory of past events by the RNN 30 helps capture context, making the RNN 30 valuable for behavior detection across the commerce sector.

The AGAN 40 is 1a generative adversarial network (GAN) or a conditional generative adversarial network (CGAN).

The AGAN 40 includes a generator 41 and as discriminator 42. The generator 41 generates synthetic images and feeds the synthetic images to the discriminator 42. The discriminator 42 attempts to distinguish real and synthetic images and outputs whether each image received from the generator 41 is real or synthetic.

The generator 41 is initially trained to generate abnormal, synthetic images that are realistic, in an attempt to fool the discriminator 42 into determining the image received from the generator 41 to be a real image. The discriminator 42 is initially trained to 1distinguish between real images that are normal and synthetic images that are abnormal and to predict a probability that an image received by the discriminator is abnormal which is equivalent to predicting a probability that the image received by the discriminator is synthetic. Thus, the generator 41 competes with the discriminator 42 in a zero-sum game.

During performance (e.g., real-time performance) of the process, the generator 41 and the discriminator 42 are additionally trained as follows. If the discriminator 42 correctly identifies input abnormal data from the generator 41 as having a high probability of being synthetic, then the generator 41 model is adjusted to generate more realistic abnormal images. If the discriminator 42 incorrectly identifies input abnormal data from the generator 41 as having a low probability of being synthetic, then the discriminator 42 model is adjusted to predict a higher probability that the input abnormal data is synthetic. As a result, the training of the AGEN 40 is continuously improved throughout performance of the process and continues for subsequent performances of the process.

The AGAN 40 is a GAN or a CGAN. A CGAN is a GAN that adds context by imposing conditions or constraints that enables more precise and targeted data generation.

The N sensors collect data for use by the RNN 30 and AGEN 40 and may include, inter alia, weight sensors for object verification, RFID scanners for accurate tracking of the object, camera systems for visual surveillance of the object, barcode scanners to prevent switching of objects, motion detectors to monitor object motion and/or motion of persons or devices or machines (e.g., conveyor belt, vehicles, etc.), global positioning system (GPS) sensors to detect locations of the object, etc.

In one embodiment, any sensor of the N sensors can be an IoT sensor which is a sensor that measures and collects specific data (e.g., temperature, humidity, light, motion, pressure) and transmits the collected data over a network for processing or analysis. The IoT sensors are integral components of IoT systems which connect various entities to the Internet, allowing the entities to share data and communicate with each other or centralized systems.

The cloud of the cloud or edge computing platform 10 includes a cloud-based platform that can be used to store, manage, and analyze sensor data and other data used in the computer architecture 50, which enables remote monitoring for collecting the data, updating the data, and performing maintenance of the data.

The edge computing platform of the cloud or edge computing platform 10 can be used to process and analyze data the N sensors (e.g., IoT sensors) locally, reducing latency and improving the responsiveness within the computer architecture 50.

The cloud or edge computing platform 10 receives the sensor data from sensor1, sensor2, . . . , sensorN via communication links 11, 12, . . . 13, respectively. The computer system 20 is configured to communicate with the cloud or edge computing platform 10 via communication link 22. The RNN 30 and AGAN 40 are configured to receive the sensor data (i) directly from the cloud or edge computing platform 10 via the communication links 21 and 23, respectively or (ii) indirectly from the cloud or edge computing platform 10 via from the computer system 20 which receives the sensor data directly from the cloud or edge computing platform 10 via the communication link 22.

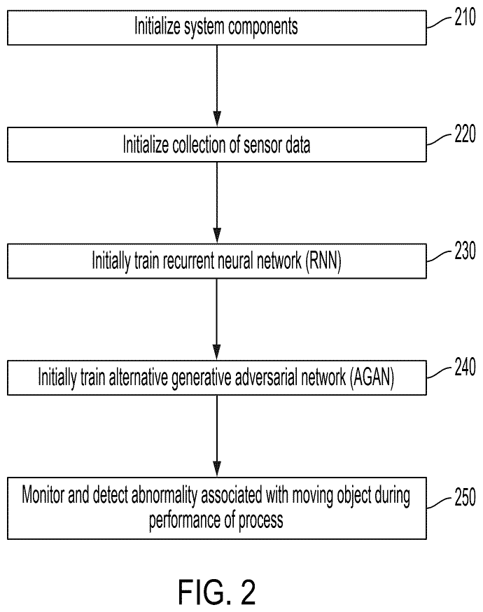

FIG. 2 is a flow chart of a method of artificial intelligence (AI) intervention to detect and mitigate an abnormality associated with an object moving during performance of a process, in accordance with embodiments of the present invention.

The flow chart in FIG. 2 includes steps 210-250.

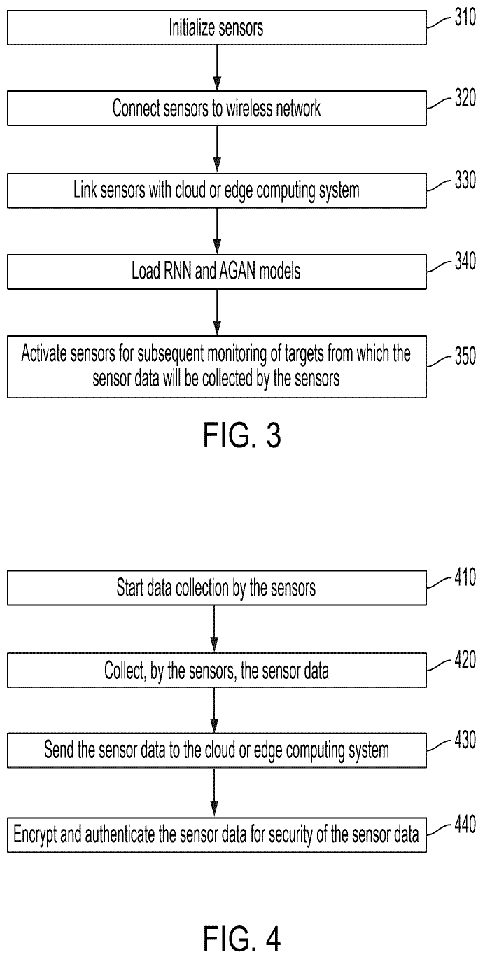

Step 210 initializes system components, which is described in detail in FIG. 3.

Step 220 initializes a collection of sensor data, which is described in detail in FIG. 4.

Step 230 initially trains the RNN 30.

Step 240 initially trains the AGAN 40.

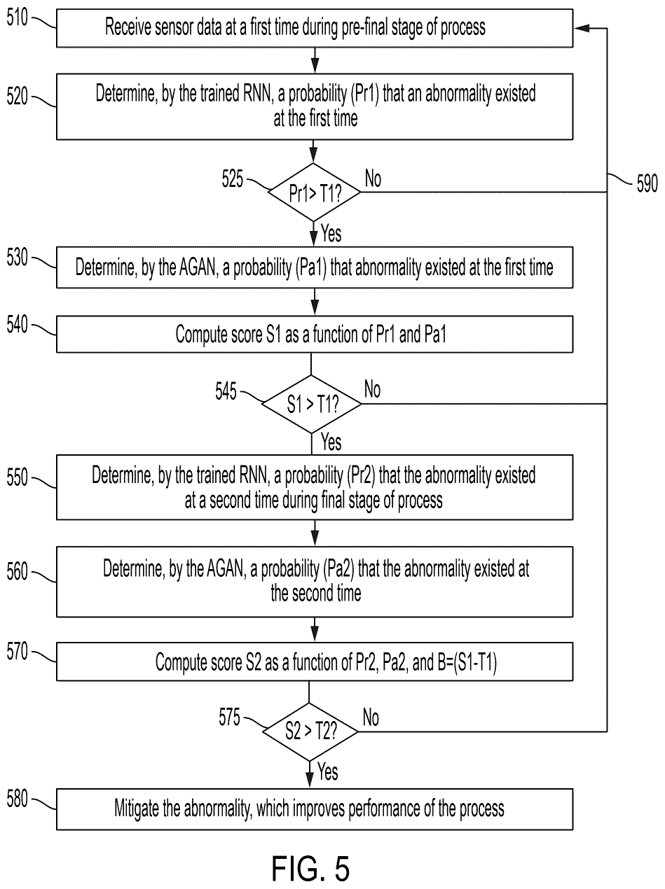

Step 250 monitors and detects an abnormality associated with a moving object during performance of a process, which is described in detail in FIG. 5.

In one embodiment, all steps 210-250 in FIG. 2 are performed in real time.

In one embodiment, one or more steps in FIG. 2 are performed in real time. For example, steps 230-250 may be performed in real time. In another example, step 250 may be performed in real time.

FIG. 3 is a flow chart describing in detail step 210 of FIG. 2 which initializes system components, in accordance with embodiments of the present invention. The flow chart in FIG. 3 includes steps 310-350.

Step 310 initializes the N sensors, which may include, inter alia, activating the N sensors for use and linking the N sensors to specific targets for collecting sensor data from, or pertaining to, the specific targets. The specific targets depend on the nature of the process and of the object.

Step 320 connects the N sensors to a wireless network (Wi-Fi®, Bluetooth®, Zigbee®, etc.)

Step 330 links the N sensors with the cloud or edge computing system 10.

In one embodiment, step 340 loads the RNN 30 and the AGAN 40 into the computer system 20. In one embodiment, step 330 is not performed because the RNN 30 and the AGAN 40 were previously loaded into the computer system 20 and thus do not have to loaded again into the computer system 20.

Step 350 activates the N sensors for subsequent monitoring of the targets from which the sensor data will be collected by the N sensors.

FIG. 4 is a flow chart describing in detail step 220 of FIG. 2 which initializes the collection of sensor data, in accordance with embodiments of the present invention. FIG. 4 includes steps 410-450.

Step 410 starts (e.g., in real time) the collection of sensor data by the N sensors.

Step 420 collects (e.g., in real time), by the N sensors, the sensor data.

Step 430 sends (e.g., in real time) the 1sensor data to the cloud or edge computing system 10 for subsequent storage of the sensor data in the cloud or edge computing system 10.

Step 440 encrypts and authenticates (e.g., in real time) the sensor data for security of the sensor data.

FIG. 5 is a flow chart describing in detail step 250 of FIG. 2, which monitors and detects an abnormality associated with a moving object during performance of a process, in accordance with embodiments of the present invention. The flow chart in FIG. 5, which includes steps 510-580, includes loop 590 which encompasses 510-575. The loop 590 is in accordance with the sensor data being continuously collected over time by the N sensors.

Step 510 receives, at a first time during a pre-final stage of the process, sensor data previously collected by the N sensors. The sensor data tracks aspects of the moving object. The sensor data, which is received from the cloud or edge computing system 10 where the sensor data is stored, is received by the RNN 30 and the AGAN 40 as well as by the computer system 20 generally.

Step 520 determines, by the trained RNN 30, a probability (Pr1) that an abnormality existed at the first time during the pre-final stage of the process.

Step 525 determines whether Pr1 exceeds a specified threshold T1, 1wherein 0<T1<100. If so (Yes branch from step 525), step 530 is next executed. If not (No branch from step 525), processing loops back to step 510 to continue to receive the sensor data (e.g., in real time).

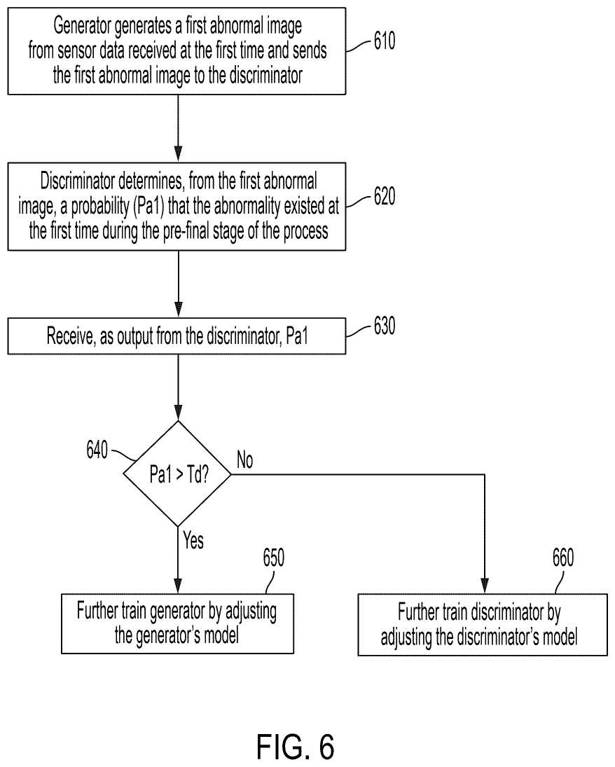

Step 530 determines, by the trained AGAN 40 from the received sensor data collected by the N sensors at the first time, a probability (Pa1) that the abnormality existed at the first time, wherein the AGAN 40 comprises the generator 41 and the discriminator 42, and wherein said determining the probability Pa1 comprises further training the AGAN by improving only the generator 41 or only the discriminator 42. Step 530 is described in more detail in FIG. 6.

Step 540 computes a score S1 as a function of Pr1 and Pa1, wherein 0<S1<100.

In one embodiment, the score S1 is computed as a linear function of Pr1 and/or Pa1 according to 1S1=w1*Pr1+w2*Pa1, wherein w1 and w2 are real numbers subject to 0<w1<1, 0<w2<1, and w1+w2=1.

In one embodiment, the score S1 is computed as a non-linear function of Pr1 and/or Pa1 according to S1=w1*(Pr1)^{r1}+w2*(Pa1)^{r2}, wherein w1 and w2 are real numbers subject to 0<w1<1, 0<w2<1, and w1+w2=1, and wherein r1 and r2 are finite positive real numbers subject to r1, r2, or both r1 and r2 being unequal to 1.

Step 545 determines whether S1 exceeds T1. If so (Yes branch from step 545), step 550 is next executed. If not (No branch from step 545), processing loops back to step 510 to continue to receive the sensor data (e.g., in real time).

Step 550 determines, by the trained RNN 30 from the received sensor data collected by the N sensors at a second time during a final stage of the process, a probability (Pr2), respectively, that the abnormality existed at the second time.

Step 560 determines, by the trained AGAN 40 from the received sensor data collected by the N sensors at the second time, a probability (Pa1) that the abnormality existed at the second time, wherein determining the probability Pa1 comprises further training the AGAN 40 by improving only the generator 41 or only the discriminator 42. Step 560 is described in more detail in FIG. 6.

Step 570 computes a score S2 as a function of Pr2, 1Pa2, and a T1 breach B=(S1−T1), wherein 0<S2<100.

In one embodiment, the score S2 is computed as a linear function of Pr2, Pa2, and B according to 1 1S2=w3*Pr2+w4*Pa2+w5*B, wherein w3, w4, and w5 are real numbers subject to 0<w3<1, 0<w4<1, 0<w5<1, and w3+w4+w5=1.

In one embodiment, the score S2 is computed as a non-linear function of Pr2 and/or Pa2 and/or B according to 1S2=w3*(Pr2)^{r3}+w4*(Pa2)^{r4}+w5*B^{r5}, wherein w3, w4, and w5 are real numbers subject to 0<w3<1, 0<w4<1, 0<w5<1, w3+w4+w5=1, and wherein r3, r4, and r5 are finite positive real numbers subject to at least one of r3, r4, and r5 being unequal to 1.

Step 575 determines whether S2 exceeds a specified threshold T2, 1wherein T1<T2<100. If so (Yes branch from step 575), step 580 is next executed. If not (No branch from step 575), processing loops back to step 510 to continue to receive the sensor data (e.g., in real time).

Step 580 mitigates the abnormality, which improves performance of the process

Mitigating the abnormality depends on the process and the object.

For example, if 1the process is a commercial transaction and (i) the object can be purchased via the commercial transaction, (ii) the abnormality associated with the object is indicative of a fraudulent activity associated with the object, (iii) 1the final stage of the process comprises a self-checkout for purchase of the object, (iv) and 1the fraudulent activity is configured to result in a discrepancy in a transaction amount representing a price of the object, then the abnormality may be mitigated via (a) adjusting, during the self-checkout, the transaction amount to eliminate the discrepancy; and (b) auto-charging, during the self-checkout, the adjusted transaction amount to a customer associated with the object during the process.

For example, if 1the process is 1an assembly line process and the object is a part being moved on an assembly line via the assembly line process to a destination at which the part is to be assembled into a machine being manufactured, and the abnormality associated with the object is indicative of a wrong object at a given time in a given position of the object on the assembly line, then the abnormality may be mitigated via removing the object from the assembly line to correctly identify the object.

For example, if 1the process is 1a delivery process and the object is to be delivered to a destination by a vehicle via the delivery process, and the abnormality associated with the object is indicative of the object being hidden in a slacks pocket of a driver of the vehicle, then the abnormality may be mitigated via informing law enforcement of the abnormality and requesting that law enforcement stop the vehicle to question the driver of the vehicle about the abnormality.

For example, if 1the process is 1a medical diagnostic process and the part is a radioactive tracer that is moved through a portion of patient's body to provide information needed by the medical diagnostic process to diagnose a medical condition of the patient 1and the object is a radioactive tracer that is moved through a portion of patient's body to provide information needed by the medical diagnostic process to diagnose a medical condition of the patient, and the abnormality associated with the object is indicative of the object being in a wrong part of the patient's body, then the abnormality may be mitigated via immediately stopping the medical diagnostic process.

FIG. 6 is a flow chart describing in detail step 530 of FIG. 5, which 1determines, by the AGAN 40, a probability (Pa1) that an abnormality existed at a first time 1during a pre-final stage of the process, in accordance with embodiments of the present invention. The flow chart in FIG. 5 includes steps 610-660.

Step 610 generates, by the generator 41, a 1first abnormal image from the sensor data received at the first time and sends the first abnormal image to the discriminator 42.

Step 620 determines, by the discriminator 42, 1a probability (Pa1) that the abnormality existed at the first time during the pre-final stage of the process.

Step 630 receives, as output from the discriminator 42, Pa1.

Step 640 determines whether Pa1 exceeds a 1discriminator accuracy threshold Td, 1wherein 0<Td<100. If so (Yes branch from step 640), step 650 is next executed. If not (No branch from step 640), step 660 is next executed.

Step 660 uses the first abnormal image to further train the generator 41 to adjust the model of the generator 41 to generate abnormal images more likely to fool the discriminator 42 into predicting lower probabilities that synthetic abnormal images received by the discriminator 42 from the generator 41 are abnormal.

Step 670 uses1 the first abnormal image to further train the discriminator 42 to adjust the model of the discriminator 42 to predict higher probabilities that synthetic abnormal images received by the discriminator 42 from the generator 41 are abnormal.

Thus, the determination of the probability Pa1 during performance (e.g., in real time) of the process includes further training the AGAN 40 by further training either the generator 41 or the discriminator 42, which is distinct from the initial training step 240 (see FIG. 2) of the AGAN.

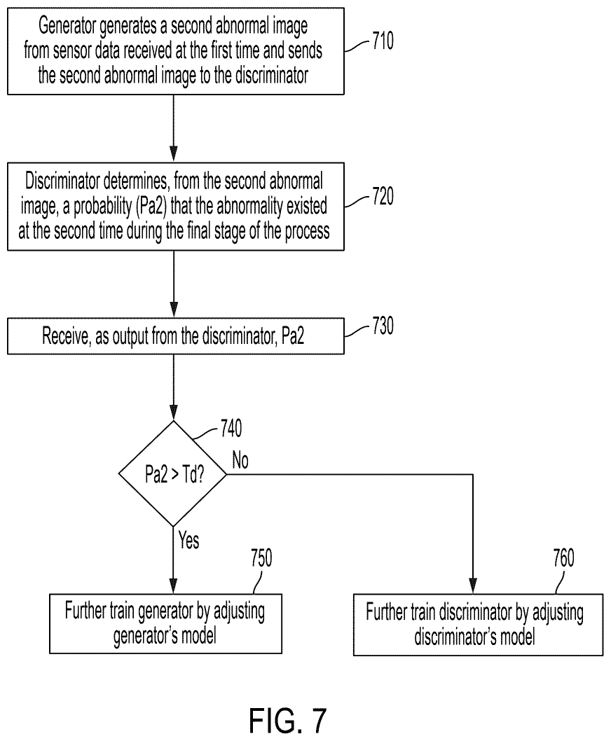

FIG. 7 is a flow chart describing in detail step 560 of FIG. 5, which 1determines, by the AGAN 40, a probability (Pa2) that an abnormality existed at a second time 1during a final stage of the process, in accordance with embodiments of the present invention. The flow chart in FIG. 5 includes steps 710-760.

Step 710 generates, by the generator 41, a 1second abnormal image from the sensor data received at the second time and sends the second abnormal image to the discriminator 42.

Step 720 determines, by the discriminator 42, 1a probability (Pa2) that the abnormality existed at the second time during the final stage of the process.

Step 730 receives, as output from the discriminator 42, Pa2.

Step 740 determines whether Pa2 exceeds the 1discriminator accuracy threshold Td. If so (Yes branch from step 740), step 750 is next executed. If not (No branch from step 740), step 760 is next executed.

Step 760 uses the second abnormal image to further train the generator 41 to adjust the model of the generator 41 to generate synthetic abnormal images more likely to fool the discriminator 42 into predicting lower probabilities that abnormal images received by the discriminator 42 from the generator 41 are abnormal.

Step 770 uses1 the second abnormal image to further train the discriminator 42 to adjust the model of the discriminator 42 to predict higher probabilities that abnormal images received by the discriminator 42 from the generator 41 are abnormal.

Thus, the determination of the probability Pa2 during performance (e.g., in real time) of the process includes further training the AGAN 40 by further training either the generator 41 or the discriminator 42, which is distinct from the initial training step 240 (see FIG. 2) of the AGAN.

FIG. 8 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97.

The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 8 shows the computer system 90 as a particular configuration of hardware and software, any configuration of hardware and software, as would be known to a person of ordinary skill in the art, may be utilized for the purposes stated supra in conjunction with the particular computer system 90 of FIG. 8. For example, the memory devices 94 and 95 may be portions of a single memory device rather than separate memory devices.

1A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 9 depicts a computing environment 100 which contains an example of an environment for the execution of at least some of the computer code involved in performing the inventive methods, in accordance with embodiments of the present invention. Such computer code includes new code for artificial intelligence (AI) intervention to detect and mitigate an abnormality associated with an object that is moving during performance of a process 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

11. A method of artificial intelligence (AI) intervention to detect and mitigate an abnormality associated with an object moving during performance of a process, said method comprising:
receiving, at a first time during a pre-final stage of the process, sensor data collected by sensors tracking aspects of the moving object;
determining, by a trained recurrent neural network (RNN) from the received sensor data collected by the sensors, a probability (Pr1) that the abnormality existed at the first time;
in response to a determination that Pr1 exceeds a specified threshold (T1) wherein 0<T1<100, determining, by an initially trained alternative generative adversarial network (AGAN) from the received sensor data collected by the sensors at the first time, a probability (Pa1) that the abnormality existed at the first time, wherein the AGAN is a generative adversarial network (GAN) or a conditional generative adversarial network (CGAN), wherein the AGAN comprises a generator and a discriminator, and wherein said determining Pa1 comprises further training the AGAN by improving only the generator or only the discriminator;
computing a score S1 as a function of Pr1 and Pa1, wherein 0<S1<100;
determining that S1 exceeds T1 and in response, determining, by the trained RNN and the trained AGAN from the received sensor data collected by the sensors at a second time during a final stage of the process, a probability (Pr2) and a probability (Pa2), respectively, that the abnormality existed at the second time, and wherein said determining Pa2 comprises additionally training the AGAN by improving only the generator or only the discriminator;
computing a score S2 as a function of at least Pr2, Pa2, and a T1 breach B=(S1−T1), wherein 0<S2<100; and
determining that S2 exceeds a specified threshold (T2) wherein T1<T2<100 and in response, mitigating the abnormality, said mitigating improving the performance of the process.

2. The method of claim 1, wherein the discriminator has been initially trained to distinguish between real images that are normal and synthetic images that are abnormal and to predict a probability that an image received by the discriminator is abnormal which is equivalent to predicting a probability that the image received by the discriminator is synthetic.

3. The method of claim 2, wherein said determining Pa1 comprises:
receiving, as output from the discriminator, Pa1 which was determined by the discriminator to be a probability that a first abnormal image received by the discriminator from the generator is abnormal, said first abnormal image having been generated by the generator from the sensor data received at the first time;
in response to Pa1 exceeding a discriminator accuracy threshold Td wherein 0<Td<100, using the first abnormal image to further train the generator to adjust the generator's model to generate abnormal images more likely to fool the discriminator into predicting lower probabilities that abnormal images received by the discriminator from the generator are abnormal;
in response to Pa1 not exceeding the discriminator accuracy threshold, using the first abnormal image to further train the discriminator to adjust the discriminator's model to predict higher probabilities that abnormal images received by the discriminator from the generator are abnormal.

4. The method of claim 2, wherein said determining Pa2 comprises:
receiving, as output from the discriminator, Pa2 which was determined by the discriminator to be a probability that a second abnormal image received by the discriminator from the generator is abnormal, said second abnormal image having been generated by the generator from the sensor data received at the second time;
in response to Pa2 exceeding the discriminator accuracy threshold, using the second abnormal image to further train the generator to adjust the generator's model to generate abnormal images more likely to fool the discriminator into predicting lower probabilities that abnormal images received by the discriminator from the generator are abnormal;
in response to Pa2 not exceeding the discriminator accuracy threshold, using the second abnormal image to further train the discriminator to adjust the discriminator's model to predict higher probabilities that abnormal images received by the discriminator from the generator are abnormal.

5. The method of claim 1, wherein the method is performed in real time.

6. The method of claim 1,
wherein said computing the score S1 comprises computing S1 according to S1=w1*Pr1+w2*Pa1, wherein w1 and w2 are real numbers subject to 0<w1<1, 0<w2<1, and w1+w2=1, and
wherein said computing the score S2 comprises computing S2 according to S2=w3*Pr2+w4*Pa2+w5*B, wherein w3, w4, and w5 are real numbers subject to 0<w3<1, 0<w4<1, 0<w5<1, and w3+w4+w5=1.

7. The method of claim 1, wherein the AGAN is the GAN.

8. The method of claim 1, wherein the AGAN is the CGAN.

9. The method of claim 1, wherein the sensors are Internet of Things (IoT) sensors, and wherein the method comprises:
storing the collected sensor data in a cloud or an edge storage device from which the sensor data is received via said receiving the sensor data.

10. The method of claim 1, wherein the process is a commercial transaction and the object can be purchased via the commercial transaction, and wherein the abnormality associated with the object is indicative of a fraudulent activity associated with the object.

11. The method of claim 10, wherein the final stage of the process comprises a self-checkout for purchase of the object.

12. The method of claim 11, wherein the fraudulent activity is configured to result in a discrepancy in a transaction amount representing a price of the object, and wherein said mitigating the abnormality comprises:
adjusting, during the self-checkout, the transaction amount to eliminate the discrepancy; and
auto-charging, during the self-checkout, the adjusted transaction amount to a customer 1associated with the object during the process.

13. A computer program product, comprising one or more computer readable hardware storage devices having computer readable program code stored therein, said program code containing instructions executable by one or more processors of a computer system to implement a method 1of artificial intelligence (AI) intervention to detect and mitigate an abnormality associated with an object moving during performance of a process, said method comprising:
receiving, at a first time during a pre-final stage of the process, sensor data collected by sensors tracking aspects of the moving object;
determining, by a trained recurrent neural network (RNN) from the received sensor data collected by the sensors, a probability (Pr1) that the abnormality existed at the first time;
in response to a determination that Pr1 exceeds a specified threshold (T1) wherein 0<T1<100, determining, by an initially trained alternative generative adversarial network (AGAN) from the received sensor data collected by the sensors at the first time, a probability (Pa1) that the abnormality existed at the first time, wherein the AGAN is a generative adversarial network (GAN) or a conditional generative adversarial network (CGAN), wherein the AGAN comprises a generator and a discriminator, and wherein said determining Pa1 comprises further training the AGAN by improving only the generator or only the discriminator;
computing a score S1 as a function of Pr1 and Pa1, wherein 0<S1<100;
determining that S1 exceeds T1 and in response, determining, by the trained RNN and the trained AGAN from the received sensor data collected by the sensors at a second time during a final stage of the process, a probability (Pr2) and a probability (Pa2), respectively, that the abnormality existed at the second time, and wherein said determining Pa2 comprises additionally training the AGAN by improving only the generator or only the discriminator;
computing a score S2 as a function of at least Pr2, Pa2, and a T1 breach B=(S1−T1), wherein 0<S2<100;
determining that S2 exceeds a specified threshold (T2) wherein T1<T2<100 and in response, mitigating the abnormality, said mitigating improving the performance of the process.

14. The computer program product of claim 13, wherein the discriminator has been initially trained to distinguish between real images that are normal and synthetic images that are abnormal and to predict a probability that an image received by the discriminator is abnormal which is equivalent to predicting a probability that the image received by the discriminator is synthetic.

15. The computer program product of claim 14, wherein said determining Pa1 comprises:
receiving, as output from the discriminator, Pa1 which was determined by the discriminator to be a probability that a first abnormal image received by the discriminator from the generator is abnormal, said first abnormal image having been generated by the generator from the sensor data received at the first time;
in response to Pa1 exceeding a discriminator accuracy threshold Td wherein 0<Td<100, using the first abnormal image to further train the generator to adjust the generator's model to generate abnormal images more likely to fool the discriminator into predicting lower probabilities that abnormal images received by the discriminator from the generator are abnormal;
in response to Pa1 not exceeding the discriminator accuracy threshold, using the first abnormal image to further train the discriminator to adjust the discriminator's model to predict higher probabilities that abnormal images received by the discriminator from the generator are abnormal.

16. The computer program product of claim 14, wherein said determining Pa2 comprises:
receiving, as output from the discriminator, Pa2 which was determined by the discriminator to be a probability that a second abnormal image received by the discriminator from the generator is abnormal, said second abnormal image having been generated by the generator from the sensor data received at the second time;
in response to Pa2 exceeding the discriminator accuracy threshold, using the second abnormal image to further train the generator to adjust the generator's model to generate abnormal images more likely to fool the discriminator into predicting lower probabilities that abnormal images received by the discriminator from the generator are abnormal;
in response to Pa2 not exceeding the discriminator accuracy threshold, using the second abnormal image to further train the discriminator to adjust the discriminator's model to predict higher probabilities that abnormal images received by the discriminator from the generator are abnormal.

17. A computer system, comprising one or more processors, one or more memories, and one or more computer readable hardware storage devices, said one or more hardware storage devices containing program code executable by the one or more processors via the one or more memories to implement a method 1of artificial intelligence (AI) intervention to detect and mitigate an abnormality associated with an object moving during performance of a process, said method comprising:
receiving, at a first time during a pre-final stage of the process, sensor data collected by sensors tracking aspects of the moving object;
determining, by a trained recurrent neural network (RNN) from the received sensor data collected by the sensors, a probability (Pr1) that the abnormality existed at the first time;
in response to a determination that Pr1 exceeds a specified threshold (T1) wherein 0<T1<100, determining, by an initially trained alternative generative adversarial network (AGAN) from the received sensor data collected by the sensors at the first time, a probability (Pa1) that the abnormality existed at the first time, wherein the AGAN is a generative adversarial network (GAN) or a conditional generative adversarial network (CGAN), wherein the AGAN comprises a generator and a discriminator, and wherein said determining Pa1 comprises further training the AGAN by improving only the generator or only the discriminator;
computing a score S1 as a function of Pr1 and Pa1, wherein 0<S1<100;
determining that S1 exceeds T1 and in response, determining, by the trained RNN and the trained AGAN from the received sensor data collected by the sensors at a second time during a final stage of the process, a probability (Pr2) and a probability (Pa2), respectively, that the abnormality existed at the second time, and wherein said determining Pa2 comprises additionally training the AGAN by improving only the generator or only the discriminator;
computing a score S2 as a function of at least Pr2, Pa2, and a T1 breach B=(S1−T1), wherein 0<S2<100;
determining that S2 exceeds a specified threshold (T2) wherein T1<T2<100 and in response, mitigating the abnormality, said mitigating improving the performance of the process.

18. The computer system of claim 17, wherein the discriminator has been initially trained to distinguish between real images that are normal and synthetic images that are abnormal and to predict a probability that an image received by the discriminator is abnormal which is equivalent to predicting a probability that the image received by the discriminator is synthetic.

19. The computer system of claim 18, wherein said determining Pa1 comprises:
receiving, as output from the discriminator, Pa1 which was determined by the discriminator to be a probability that a first abnormal image received by the discriminator from the generator is abnormal, said first abnormal image having been generated by the generator from the sensor data received at the first time;
in response to Pa1 exceeding a discriminator accuracy threshold Td wherein 0<Td<100, using the first abnormal image to further train the generator to adjust the generator's model to generate abnormal images more likely to fool the discriminator into predicting lower probabilities that abnormal images received by the discriminator from the generator are abnormal;
in response to Pa1 not exceeding the discriminator accuracy threshold, using the first abnormal image to further train the discriminator to adjust the discriminator's model to predict higher probabilities that abnormal images received by the discriminator from the generator are abnormal.

20. The computer system of claim 18, wherein said determining Pa2 comprises:
receiving, as output from the discriminator, Pa2 which was determined by the discriminator to be a probability that a second abnormal image received by the discriminator from the generator is abnormal, said second abnormal image having been generated by the generator from the sensor data received at the second time;
in response to Pa2 exceeding the discriminator accuracy threshold, using the second abnormal image to further train the generator to adjust the generator's model to generate abnormal images more likely to fool the discriminator into predicting lower probabilities that abnormal images received by the discriminator from the generator are abnormal;
in response to Pa2 not exceeding the discriminator accuracy threshold, using the second abnormal image to further train the discriminator to adjust the discriminator's model to predict higher probabilities that abnormal images received by the discriminator from the generator are abnormal.
